(19) United States
(12) Patent Application Publication
(10) Pub. No.: US 2022/0350327 A1
(43) Pub. Date: Nov. 3, 2022

(54) VEHICLE INTELLIGENT LIFTING SYSTEM

(71) Applicant: CHUNGAN TECHNOLOGY CO., LTD., Tainan City (TW)

(72) Inventors: Chung-I FANG, Tainan City (TW); Jing-Jou TANG, Tainan City (TW)

(21) Appl. No.: 17/245,129

(22) Filed: Apr. 30, 2021

(51) Int. Cl. G05D 1/00; B60R 16/023; G07C 5/08; B60P 1/44

(52) U.S. Cl. CPC G05D 1/0022; B60R 16/0232; G07C 5/0808; B60P 1/4414; B60P 1/4471; B66F 7/00

(57) ABSTRACT

A vehicle intelligent lifting system, configured to be mounted to a vehicle body including a Controller Area Network (CAN) bus, is provided, including: a control module, in communication with the CAN bus, configured to obtain a signal from the CAN bus; a lifting device, in communication with the control module; wherein the control module determines whether to control the lifting device to operate according to vehicle information from the CAN bus.

### BACKGROUND OF THE INVENTION

### Field of the Invention

The present invention relates to a vehicle intelligent lifting system.

### Description of the Prior Art

In few decades, human's life time is getting longer and longer, so the number of people who need long-term care is considerably increasing. The government and private facilities are also actively developing a perfect long-term care system and equipment in order to cope with this situation. The welfare vehicle is equipped with lifting equipment in the carriage to facilitate the transportation of wheelchair users who need long-term care.

However, the lifting equipment of the conventional welfare vehicle has the following shortcomings. In order to save time, the operator often does not turn off the welfare vehicle, pull the handbrake and carry out other safety measures when operating the lifting equipment, so the welfare vehicle will accidentally move and cause danger. Furthermore, when other vehicles are approaching, it can cause big risks to the operator in operating the lifting equipment. Therefore, these shortcomings have to be improved urgently.

The present invention is, therefore, arisen to obviate or at least mitigate the above-mentioned disadvantages.

### SUMMARY OF THE INVENTION

The main object of the present invention is to provide a vehicle intelligent lifting system which can improve the safety for operation.

To achieve the above and other objects, a vehicle intelligent lifting system, configured to be mounted to a vehicle body including a Controller Area Network (CAN) bus, is provided, including: a control module, in communication with the CAN bus, configured to obtain a signal from the CAN bus; a lifting device, in communication with the control module; wherein the control module determines whether to control the lifting device to operate according to vehicle information from the CAN bus.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is schematic view of a preferable embodiment of the present invention;

FIG. 2 is a partial stereogram of a preferable embodiment of the present invention;

FIG. 3 is a block diagram of a preferable embodiment of the present invention;

and

FIG. 4 is schematic view of another preferable embodiment of the present invention.

### DETAILED DESCRIPTION OF THE PREFERRED EMBODIMENTS

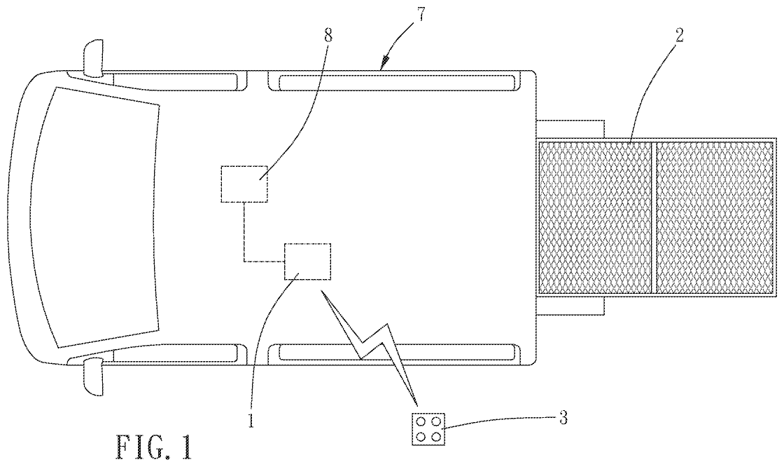

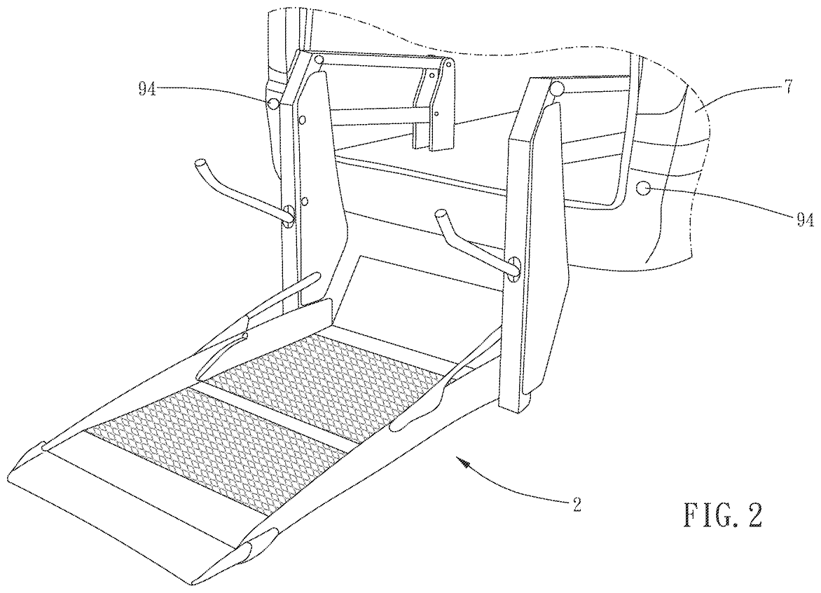

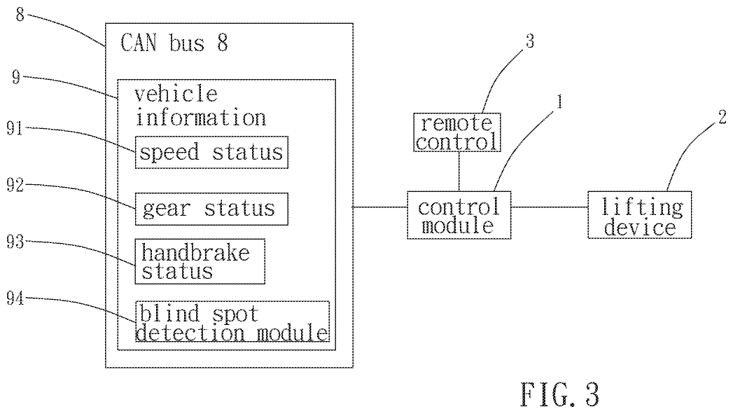

Please refer to FIGS. 1 to 3 for a preferable embodiment of the present invention. A vehicle intelligent lifting system of the present invention is configured to be mounted to a vehicle body 7 including a Controller Area Network (CAN) bus 8. The vehicle intelligent lifting system includes a control module 1 and a lifting device 2.

The control module 1 is in communication with the CAN bus 8 and configured to obtain a signal from the CAN bus 8.

The lifting device 2 is in communication with the control module 1.

The control module 1 determines whether to control the lifting device 2 to operate according to vehicle information 9 from the CAN bus 8. Whereby, the control module 1 can determine whether it is the right time to operate the lifting device 2 according to the vehicle information 9 from the CAN bus 8, which ensures safety operation of the lifting device 2.

The vehicle information 9 may include at least one of speed status 91, gear status 92 and handbrake status 93. In this embodiment, the vehicle information 9 includes speed status 91, gear status 92 and handbrake status 93, and the control module 1 does not turn on the power of the lifting device 2 until the speed status is 0 km/h, the gear status is under a parking mode and the handbrake is applied; otherwise, the power of the lifting device 2 is not turned on. This can avoid damager due to unintentional operation of the lifting device 2 as the vehicle is moving.

Preferably, the vehicle intelligent lifting system further includes a remote control 3, the remote control 3 is in communication with the control module 1, and the remote control 3 is configured to input a control signal to the control module 1 for controlling the lifting device 2. Preferably, the remote control 3 is in communication with the control module 1 by Bluetooth, and there needs no one to stand near the vehicle body 7, which is highly safe and avoids damage to wires of the wired controller.

The CAN bus 8 may be in communication with a blind spot detection module 94. When the blind spot detection module 94 detects a vehicle near the vehicle body 7, the CAN bus 8 transmits an associated signal to the control module 1, and the control module 1 turns off the power of the lifting device 2, for avoiding risks during operating the lifting device 2 as there is the vehicle near the vehicle body 7.

In this embodiment, the control module 1 is connected with an on-board diagnostic (OBD-II) interface connected with the CAN bus 8 so that control module 1 can be in communication with the CAN bus 8 well. In other embodiment, the control module 1 may be in communication with the CAN bus 8, which avoids damage to wires for transmitting signals.

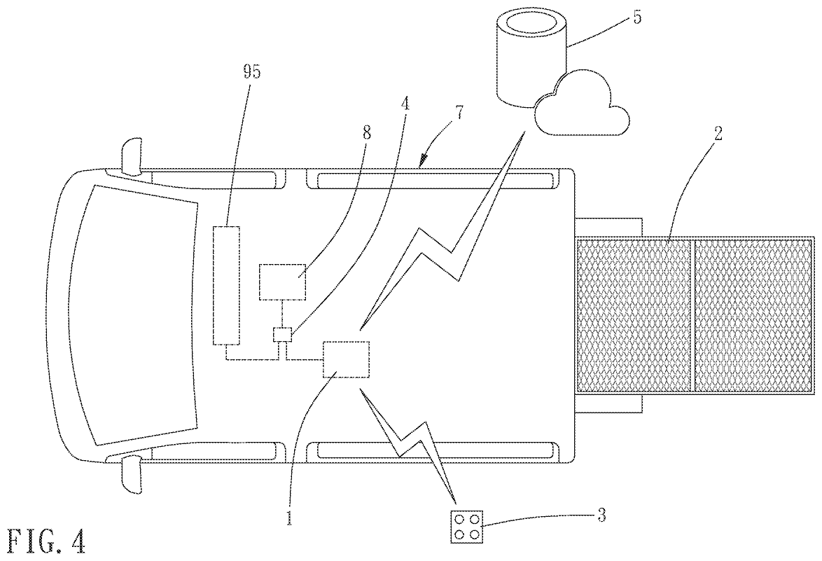

Please refer to FIG. 4, in an alternative embodiment, the vehicle intelligent lifting system further includes an adapter 4, the adapter 4 is connected with an on-board diagnostic interface connected with the CAN bus 8, the control module 1 is connected with the adapter 4, and the adapter 4 is configured to be connected with a vehicle-mounted computer 95 mounted to the vehicle body 7. The adapter 4 is configured to connect both the control module 1 and the vehicle-mounted computer 95 to the CAN bus 8, which allows the vehicle-mounted computer 95 to be additionally mounted to the vehicle body 7 easily.

The vehicle intelligent lifting system may further include a cloud processing center 5, the cloud processing center 5 is in communication with the control module 1 via an internet, and the control module 1 transmits the vehicle information 9 to the cloud processing center 5. The vehicle information 9 may include information of at least one of battery capacity, fuel capacity and mileage of the vehicle body 7 so that the cloud processing center 5 can immediately obtain circumstances or states of the vehicle body 7. The cloud processing center 5 may be in communication with an advanced driver assistance systems (ADAS) mounted on the vehicle body 7, for security monitoring.

The vehicle intelligent lifting system is in communication with the CAN bus, the external information of the vehicle can be transmitted and stored into the computer on the vehicle, which improving judgment in driving information and achieves vehicle-to-everything (V2X) vehicle-to-vehicle (V2V) or the like.

This allows vehicles to transmit wireless signals and communicate with each other (in V2V) or with any objects (in V2X), which effectively reduces risks of collision or loss of control, improves controllability and stability of the vehicle, ensures the safety of the cargo, personnel, battery on the vehicle, and lowers risk of traffic accidents and impact magnitude in traffic accidents.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A vehicle intelligent lifting system, configured to be mounted to a vehicle body, the vehicle body including a Controller Area Network (CAN) bus, the vehicle intelligent lifting system including:
a control module, in communication with the CAN bus, configured to obtain a signal from the CAN bus;
a lifting device, in communication with the control module;
wherein the control module determines whether to control the lifting device to operate according to vehicle information from the CAN bus.

2. The vehicle intelligent lifting system of claim 1, wherein the vehicle information from the CAN bus includes at least one of speed status, gear status and handbrake status.

3. The vehicle intelligent lifting system of claim 2, wherein the control module does not turn on the power of the lifting device until the speed status is 0 km/h, the gear status is under a parking mode and the handbrake is applied.

4. The vehicle intelligent lifting system of claim 1, further including a remote control, wherein the remote control is in communication with the control module, and the remote control is configured to input a control signal to the control module for controlling the lifting device.

5. The vehicle intelligent lifting system of claim 4, wherein the remote control is in communication with the control module by Bluetooth.

6. The vehicle intelligent lifting system of claim 1, wherein the CAN bus is in communication with a blind spot detection module, and when the blind spot detection module detects a vehicle near the vehicle body, the CAN bus transmits an associated signal to the control module, and the control module turns off the power of the lifting device.

7. The vehicle intelligent lifting system of claim 2, wherein further including a cloud processing center, wherein the cloud processing center is in communication with the control module via an internet, and the control module transmits the vehicle information to the cloud processing center.

8. The vehicle intelligent lifting system of claim 1, wherein the control module is connected with an on-board diagnostic (OBD-II) interface connected with the CAN bus.

9. The vehicle intelligent lifting system of claim 1, wherein the control module is in communication with the CAN bus by Bluetooth.

10. The vehicle intelligent lifting system of claim 1, further including an adapter, wherein the adapter is connected with an on-board diagnostic (OBD-II) interface connected with the CAN bus, the control module is connected with the adapter, and the adapter is configured to be connected with a vehicle-mounted computer mounted to the vehicle body.
